(19) United States
(12) Patent Application Publication
(10) Pub. No.: US 2018/0353003 A1
(43) Pub. Date: Dec. 13, 2018

(54) Novel Sensor Probe to Monitor Temperature during Cooking

(71) Applicants: Ashok Sabata, Freehold, NJ (US); Karl Baumgartner, Lausanne (CH); Thierry Jayet, Lausanne (CH); Bikash Sabata, Santa Clara, CA (US)

(72) Inventors: Ashok Sabata, Freehold, NJ (US); Karl Baumgartner, Lausanne (CH); Thierry Jayet, Lausanne (CH); Bikash Sabata, Santa Clara, CA (US)

(21) Appl. No.: 15/617,501

(22) Filed: Jun. 8, 2017

(51) Int. Cl. A47J 36/00; G01K 1/02; G09B 19/00; G09B 5/04

(52) U.S. Cl. CPC A47J 36/00; G01K 1/024; H04Q 2209/43; G09B 19/0092; G09B 5/04; G01K 1/026

(57) ABSTRACT

Monitoring of food temperature during cooking for taste as well as to check if it is safe for consumption is well known, especially when grilling or bbqing or in professional kitchens. With smartphones and tablets, use of wireless thermometers that use bluetooth or WiFi are now available commercially. These thermometers use the internet cloud when needed and have apps that provide a lot of information to make cooking easier and fun. The present invention relates to an unique temperature monitoring system.

### REFERENCES CITED

### U.S. Patent Documents

8,931,400 B1 January 2015 Allen
20160044460 A1 February 2016 Cornaby et
U.S. Pat. No. 6,539,842B1 April 2003 Chapman et al.

### BACKGROUND OF THE INVENTION

Monitoring of food temperature during cooking for taste as well as to check if it is safe for consumption is well known, especially in professional kitchens. Recently wireless thermometers have been coming to the consumer market for grilling outdoors and also sometimes in the kitchens for use in ovens. With smartphones and tablets, use of wireless thermometers that use bluetooth or WiFi are now available commercially. These thermometers use the interact cloud when needed and have apps that provide a lot of information to make cooking easier and fun. The present invention and the various embodiments thereof, relate to a novel temperature monitoring system.

U.S. Publication No., 8931400 B1, entitled “Remote cooking systems and methods”, discloses, a food thermometer that uses bluetooth and works with smartphones. The use of bluetooth wireless coupled with the smartphone does eliminate the need for wireless receivers. A limitation of a bluetooth thermometer is the requirement of pairing the transmitter and receiver. With so many brands of smartphone in the market the pairing for some smartphones can many times not work at all or work poorly, making: the user experience poor, thereby discouraging use of such a thermometer.

Another limitation of existing temperature monitors, that use microelectronics used in the consumer market, is that they are not waterproofed; so cleaning them with water is a problem, especially after atypical mess created during the cooking process. Waterproof thermometers are available in commercial markets but they are not affordable for home users.

Another limitation of wireless thermometers used during cooking is the presence of wire or cable between the temperature probe and the electronics, that allows the electronics to be placed outside the hot environment. Though the wire or cable can withstand high temperatures it still is a major point of failure. In addition, the dangling wire is very inconvenient. U.S. Publication No.,6339842B1 describes a rotisserie system that includes a rotatable skewer that requires a complex solution to accommodate the presence of cable. Other examples of the cable connecting to the thermometer are well known.

As the popularity of grilling and BBQing grows, there is a need for simpler temperature monitoring solution that is affordable, monitors continuously using the myriad of smart phones and tablets and is suited for the cooking environment.

### BRIEF SUMMARY OF THE INVENTION

The summary is provided to describe in a simplified form the concepts of the current invention. It is not intended to identify key features of the claimed subject matter or to describe each disclosed embodiment or every implementation of the claimed subject matter, and is not intended to be used as an aid in determining the scope of the claimed subject matter.

As the popularity of grilling and BBQing grows, there is a need for simpler temperature monitoring solution that is affordable, monitors continuously using the myriad of smart phones and tablets and is suited for the cooking environment. An embodiment of the present invention provides a method and system for measuring temperature of food during cooking that uses a temperature sensor inside the tip of a metal probe with the electronics controlling the measurement inside the same probe; transmitting the sensor measurement directly to a smartphone or tablet using low power bluetooth. The low cost, ease of setup and other advantages and benefits of the present invention will become apparent from the detailed description of the invention.

The present invention represents a substantial advance over prior systems used for measuring food temperature. Because the present invention uses a thermoelectric cell to power the electronics thereby eliminating the need for batteries that can be hazardous in a high temperature environment. In an embodiment, the thermoelectric cell has a small form factor to fit on a temperature probe and does not use solder that allows it to withstand temperatures above 250 C. while keeping the cost affordable.

In another embodiment, the probe design is unique as it uses a wireless transmitter and protects the electronics from heat, therefore removing the need for cables and wires that are typically used to separate the temperature sensor from the electronics. Also, the unique probe design shields the thermoelectric cell from the high temperature inside the oven or on a grill. In addition the probe includes a second temperature sensor embedded m the probe to measure the air temperature inside the oven or on a grill. The probe therefore, measures both the air temperature and the food temperature at the same time.

In a further embodiment, the system uses the FastConnect method for bluetooth connectivity that eliminates the pairing problems experienced with bluetooth devices. In addition, system includes an API that allows users to write their own app to view the sensor reading on their smartphone or tablets.

### BRIEF DESCRIPTION OF THE DRAWINGS

It is noted that the appended drawings illustrate only exemplary embodiments of the invention and are, therefore, not to be considered limiting of its scope, for the invention may admit to other equally effective embodiments. For the present invention to be clearly understood and readily practiced, the present Invention will be described in conjunction with the following figures; wherein:

FIG. 1 is a diagram illustrating the sensor probe;

FIG. 2 Is an illustration of the heat exchanger;

FIG. 3 is a diagram illustrating the communication between the probe, smartphone and the interact cloud.

### DETAILED DESCRIPTION OF THE INVENTION

While the present invention will be described more fully it is to be understood at the outset of the description which follows that persons of skill in the appropriate arts may modify the invention herein described while still achieving the favorable results of this invention. Accordingly, the description which follows is to be understood as being a broad, teaching disclosure directed to persons of skill m the appropriate arts, and not as limiting upon the present invention.

First briefly in overview, the present invention according to one or more embodiments is a unique device; called T-Bolt, with sensors, bluetooth communication system, thermoelectric cell, software programs, and related methods for temperature monitoring that works with smartphones and tablets. The system is for consumer use to measure the food temperature during cooking; grilling or barbecuing.

FIG. 1 illustrates the sensor probe with its various components including a dual temperature measuring circuit, a bluetooth module, power module to power the device and the packaging to protect the electronics from the high temperature. The dual temperature sensing system includes the sensing, element that measures the temperature of the metal probe tip which measures the food temperature, another sensing element that measures the air temperature which is the cooking temperature, and the sensor electronics. The bluetooth module transmits the temperature measurements to the smartphone or tablet.

In the current invention the sensor probe is powered through a rechargeable battery or a thermoelectric module. When using a rechargeable battery, the sensor electronics and the bluetooth communications system has to be tethered from the sensing element as they cannot withstand the heat of the grill during cooking. In an embodiment the rechargeable battery, the sensor electronics and the bluetooth module can be embedded inside the probe and they would be protected from the heat as the probe is inserted inside the food which is at a much lower temperature.

In a preferred embodiment the current invention uses a thermoelectric module that generates electricity to power the sensor electronics and the bluetooth communications system; the thermoelectric module is connected to a hot side which is the air temperature and a cool side which is the food temperature and the temperature difference between the two, is used to generate power. Unlike a rechargeable battery the thermoelectric module does not require a recharging station.

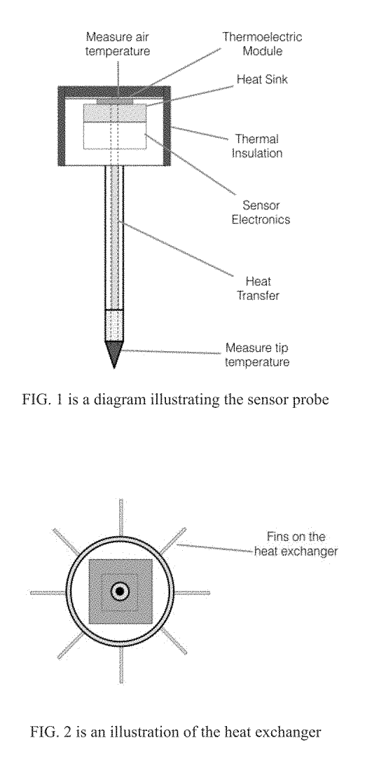

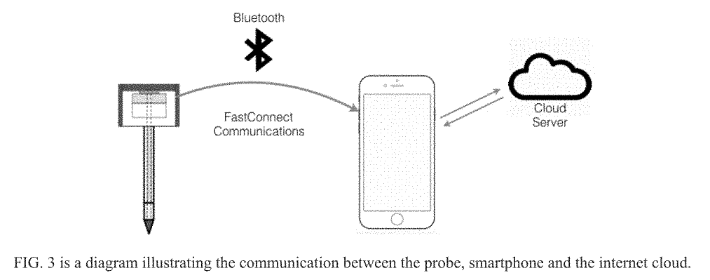

In another embodiment the thermoelectric module is connected to a heat exchanger and a heat sink so as to get as much heat flux as possible. FIG. 2 illustrates the heat exchanger design to absorb the heat from the air. The heat sink is shown in FIG. 1. Thermal insulation around the electronics and the heat sink isolates it from the hot air. The thermoelectric module connects to the electronics with two wires and delivers pure DC power that is then regulated to the desired level.

In the current invention the bluetooth communications uses the FastConnect technology that uses the bluetooth beacon wherein the sensor does not require pairing with a smartphone; thereby eliminating known pairing problems as well as improving the user experience by reducing the response time to view the sensor data. In addition, the FastConnect technology allows one sensor to communicate to as many smartphones or tablets as necessary.

In another embodiment when using rechargeable batteries the time between charges is extended to at most once a month, preferably once a quarter; an accelerometer coupled with a rules based engine defines when to put the electronics in a low power mode or to put it to sleep thereby reducing the power consumption. An accelerometer wakes up the electronics and stays on for a predetermined amount of time, measuring temperature and transmitting the reading via bluetooth to a smartphone. A mules based software engine is implemented on the sensor probe to extend the wake up time; for example if the air temperature is above 100 C. the sensor probe should continue to keep measuring and transmitting.

In the current invention the app used to display temperature readings is integrated with a digital assistant that uses a voice interface to alert as well as search for recipes or share the cooking experience with others. The digital assistant uses an intelligent engine to learn the cooks preferences and provide relevant information while cooking.

What is claimed is:

1. A system for monitoring the an temperature and the food temperature during cooking in a high temperature environment, the system comprising:
a dual temperature probe for measuring air temperature and food temperature at the same time,
a thermoelectric module to convert heat into electricity to power the system;
a heat exchanger and heat sink to create a temperature difference for the thermoelectric module;
an electronics system in the probe to wirelessly transmit the temperature data to a smartphone or a tablet or a digital assistant;
an insulation to protect the electronics and isolate the heat sink:
an app extracting the information from the sensor data and communicating to the user the status of the cooking;

2. The system of claim 1 wherein the dual probe can measure temperature up to 400 C.

3. The system of claim 1 wherein the dual probe is water resistant with a minimum LP rating of 61.

4. The system of claim 1 wherein the thermoelectric module has a surface area of less than 5 sq cm, preferably less than 2 sq cm.

5. The system of claim 1 wherein the heat exchanger has a minimum area of 25 sq cm, preferably between 50 to 200 sq cm.

6. The system of claim 1 wherein the heat sink is connected to the inside of the food or meat.

7. The system of claim 1 wherein the electronic system includes a bluetooth module to transmit the sensor reading.

8. The system of claim 1 wherein the electronic system includes a temperature measuring circuit.

9. The system of claim 1 wherein the electronic system regulates the voltage and current generated from the thermoelectric module.

10. A method for monitoring the air temperature and the food temperature during cooking in a high temperature environment, the method comprising:
a dual temperature probe for measuring air temperature and food temperature at the same time;
bluetooth transmitter to send the temperature reading for processing;
a portable power module to power the electronics for the probe and the bluetooth transmitter;
a timer to control when to wake up, transmit and put to sleep the electronics to conserve power from the power module;
an app to improve the cooking experience;

11. The method of claim 10 wherein the dual temperature probe can measure air temperature up to 400 C.

12. The method of claim 10 wherein the dual temperature probe, the bluetooth transmitter and the portable power module can be washed in a dishwasher.

13. The method of claim 10 wherein the bluetooth transmitter connects instantaneously to smartphones and tablets.

14. The method of claim 10 wherein the portable power module is a rechargeable battery or a thermoelectric cell.

15. The method of claim 10 wherein the timer is activated by the accelerometer to wake up the electronics and the bluetooth transmitter to start transmitting the temperature readings.

16. The method of claim 10 wherein the timer puts the electronics to sleep after a preset amount of time when there is no movement.

17. The method of claim 10 wherein the timer keeps the electronics running and transmitting the temperature reading as long as the air temperature is above 60 C. or preferably above 100 C.

18. The method of claim 10 wherein the app displays the temperature reading, alarms on preset temperatures, provides recipes.

19. The method of claim 10 wherein the app integrates with a digital assistant that, has a learning engine with a voice interface.
